(19) United States
(12) Patent Application Publication
(10) Pub. No.: US 2010/0319297 A1
(43) Pub. Date: Dec. 23, 2010

(54) Clamp and Method of Clamping

(76) Inventor: Alan Whitby, Cheshire (GB)

Correspondence Address: BAKER & DANIELS LLP, 300 NORTH MERIDIAN STREET, SUITE 2700, INDIANAPOLIS, IN, 46204, US

(21) Appl. No.: 12/742,401

(22) PCT Filed: Nov. 11, 2008
(86) PCT No.: PCT/GB2008/003783

§ 371 Date: Sep. 8, 2010

(30) Foreign Application Priority Data
Nov. 16, 2007 (GB) 0722521.2

(51) Int. Cl. E04B 1/38; F16B 2/12

(52) U.S. Cl. 52/745.21; 24/455; 24/522

(57) ABSTRACT

According to an aspect of the present invention, there is provided a clamping apparatus (20) comprising: a first clamp provided with: a first clamp surface (21), a second clamp surface (22), and a substantially straight shaft (23), the first clamp surface and second clamp surface being arranged to be moveable relative to each other along the shaft to clamp an object between the first clamp surface and the second clamp surface, at least one of the clamp surfaces being releasably fixable, and a second clamp provided on an arm (26) which extends from the second clamp surface, the arm extending in a direction subatantially parallel to the shaft. According to another aspect of the present invention, there is provided a method of using the clamp.

The present invention relates to a clamp and a method of using that clamp.

For many years, the application of a façade to a newly constructed building was undertaken using scaffolding. Scaffolding would be erected around the newly constructed building, and workers would use the scaffolding to reach appropriate places around the external surface of the new building to apply (or complete) the façade. However, in more recent times, the use of scaffolding to apply a façade to a newly constructed building (or to refurbish and existing building) has been replaced with a technique known as curtain-walling. Whereas in the use of scaffolding the façade is applied from the outside of the building, using curtain-walling the façade may be applied from the inside of the building and supported from the floors of the building. Curtain-walling has become more popular in recent years due to the increased height of newly constructed buildings, as well as the lack of space around newly constructed buildings in densely populated areas, both of which make the use of scaffolding more difficult.

Although curtain-walling is becoming a more popular technique with which to apply a façade to a building, the methods and apparatus used to carry out curtain-walling can be improved. For example, the use of curtain-walling to apply a façade to a building requires the accurate location and alignment of substantially U-shaped channels (often referred to in the industry as Halfan channels, and generally referred to as fixing channels). Current techniques used to locate and align these U-shaped channels are not satisfactory, and can result in misalignment. If the U-shaped channels are misaligned, it is difficult or impossible to apply a façade to the building using these channels. It is often necessary to realign these U-shaped channels so that the façade can be applied to the building using the channels. Realignment of the channels may involve time consuming excavation of the channels from concrete. The time taken to realign these channels can increase the cost of the building, as well as incurring delays in the construction of the building which can incur further costs.

It is therefore an object of the present invention to obviate or mitigate at least some of the disadvantages mentioned above.

According to a first aspect of the present invention there is provided a clamping apparatus, comprising: a first clamp provided with: a first clamp surface; a second clamp surface; and a substantially straight shaft, the first clamp surface and second clamp surface being arranged to be moveable relative to each other along the shaft to clamp an object between the first clamp surface and the second clamp surface, at least one of the clamp surfaces being releasably fixable, and a second clamp provided on an arm which extends from the second clamp surface, the arm extending in a direction substantially parallel to the shaft.

According to second aspect of the present invention there is provided a method of clamping a fixing channel in position relative to a floor slab sub structure, comprising: moving at least one of a first clamp surface and a second clamp surface of a first clamp along a substantially straight shaft, and releasably fixing the at least one clamp surface to clamp between the first clamp surface and the second clamp surface side shuttering for forming a floor slab; using a second clamp which is attached to the first clamp to clamp the fixing channel so that the fixing channel is parallel to the deck shuttering for the floor slab and in a position substantially parallel to and away from the shaft.

Preferably the clamping apparatus of the invention includes a support leg for supporting the apparatus above deck shuttering for the floor slab sub structure. The leg is preferably height adjustable relative to one of the clamp surfaces. The leg may be screw threadedly adjustable.

An embodiment of the present invention will now be described by way of example only with reference to the accompanying drawings, in which:

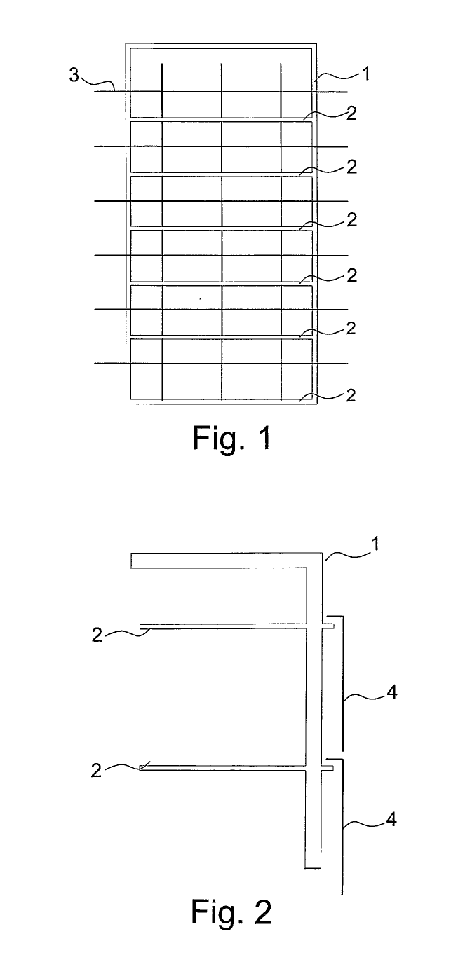

FIG. 1 depicts a construction technique using scaffolding;

FIG. 2 depicts a construction technique using curtain-walling;

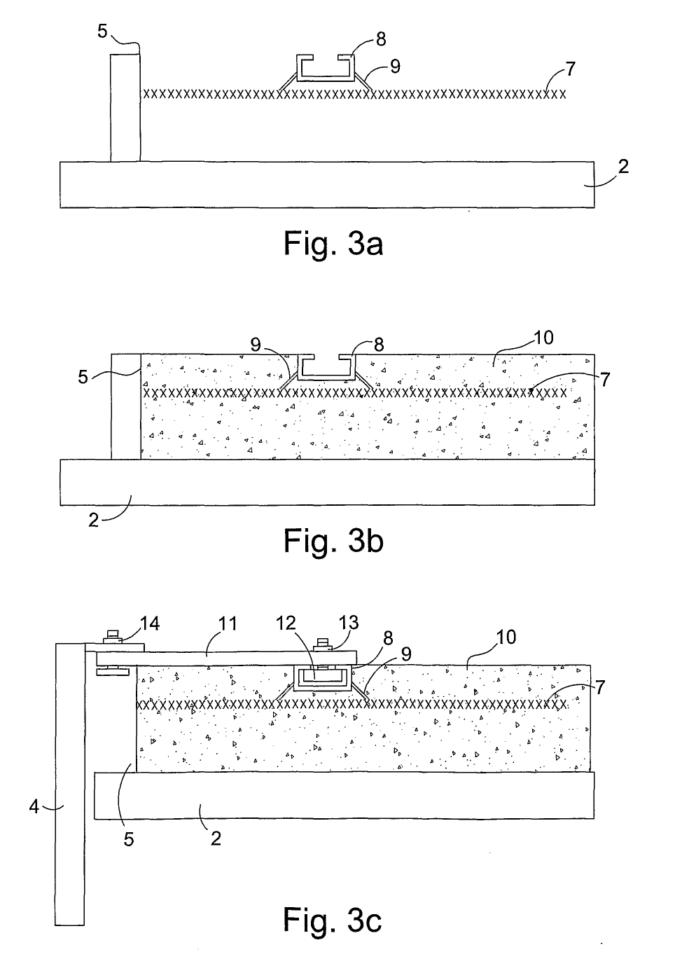

FIGS. 3a to 3c depict a method used to apply curtain-walling to a building;

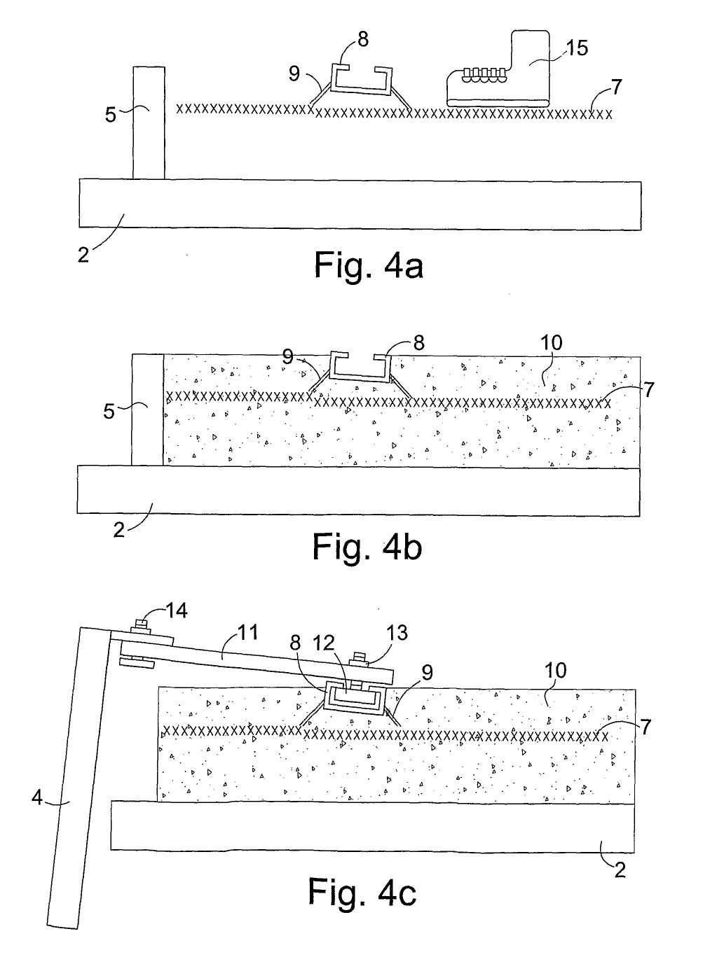

FIGS. 4a to 4c illustrate problems with prior art curtain-walling methods and apparatus;

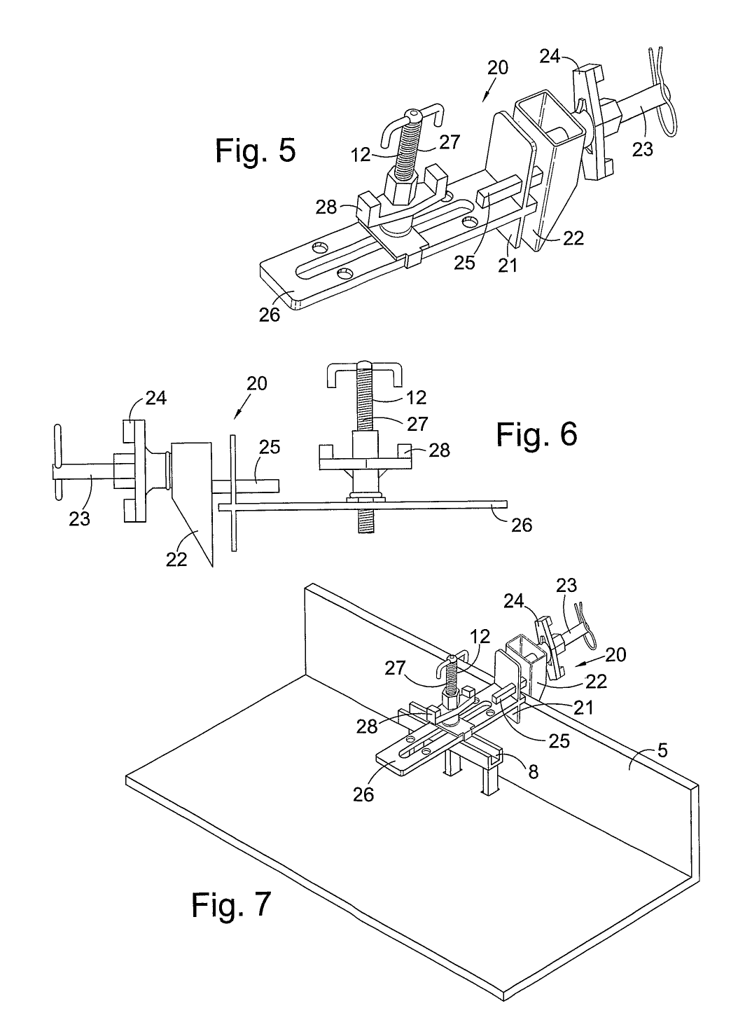

FIGS. 5 and 6 illustrate a clamp according to an embodiment of the present invention; and

FIG. 7 shows the clamp of FIGS. 5 and 6 mounted on shuttering; and

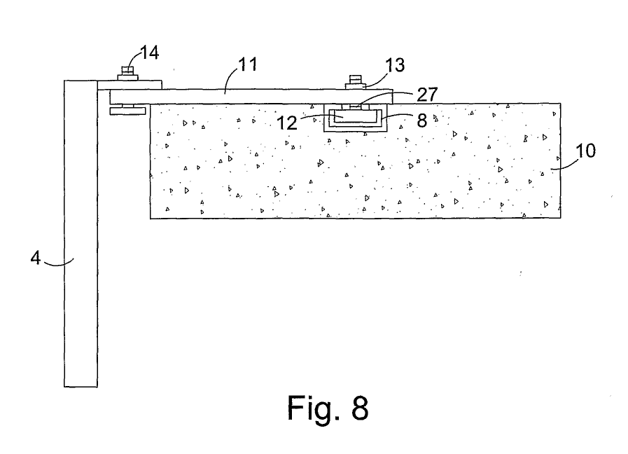

FIG. 8 shows correct attachment of curtain walling.

The above mentioned figures have not been drawn to scale. Identical features have been given identical reference numbers throughout the figures.

FIG. 1 depicts a newly constructed building 1 having a plurality of floors 2. Erected around the outside of the building 1 is scaffolding 3. The scaffolding 3 is used by, for example, builders to apply a façade to the building 1.

The use of scaffolding is not always desirable. If the building is of a certain height, the use of scaffolding may not be appropriate or even safe. Furthermore, if space around the building is restricted, the use of scaffolding may not be possible. Thus, the use of curtain-walling in recent years has become more popular.

FIG. 2 illustrates the basics of curtain-walling. FIG. 2 illustrates part of a building 1, which has a plurality of floors 2. Two curtain-walling sections 4 are also shown. The curtain-walling sections 4 are suspended from and attached to the flooring 2 of the building 1. The exact fixing mechanisms are not shown in FIG. 2. It will be appreciated that the curtain-walling sections 4 may be glazing, cladding, etc. Because the curtain-walling sections 4 are attached to and suspended from the floors 2 of the building, the curtain-walling sections 4 may be attached without the use of scaffolding. The curtain-walling sections may be lifted into position by crane and attached to the building 1 by workers working on the inside of the building 1. Alternatively, the curtain-walling sections 4 may be delivered to the fixing points at the outer surfaces of the building 1 from within the building itself 1.

A typical apparatus and method for fixing the curtain-walling to the sides of buildings is shown in FIGS. 3a to 3c. Shown in FIG. 3a is deck shuttering 2 of a building (the building is not shown in the Figure). The floor slab is formed using deck shuttering and side shuttering. The side shuttering 5 is positioned adjacent to the outer edge of the building. Located above the deck shuttering 2 is a layer of metal mesh 7. The metal mesh 7 is positioned such that it is substantially parallel to the deck shuttering 2. An elongate substantially U-shaped channel 8 is fixed to the mesh 7 by way of fixings 9. Although the elongation of the substantially U-shaped channel 8 cannot be directly seen from FIG. 3a, the U-shaped channel 8 is elongate in that it extends into and out of the page containing FIG. 3a (and all Figures illustrating the U-shaped channel 8). The fixings 9 are positioned such that the top of the U-shaped channel 8 is level with the upper point of the side shuttering 5.

It can be seen from the Figure that the substantially U-shaped channel 8 is not exactly U-shaped, but has inwardly facing lips. The lips are used to prevent a fixing element from moving out of the channel when the fixing element has been appropriately positioned in the channel (as described below). The substantially U-shaped channel 8 is abbreviated to ‘U-shaped channel’ hereafter.

Once the construction of FIG. 3a has been completed, concrete 10 is poured through the metal mesh 7 up to the level of the top of the side shuttering 5 and the top of the U-shaped channel 8. The concrete 10 is allowed to set such that the U-shaped channel 8 is fixed in position. The U-shaped channel 8 then acts as a fixing channel for additional structures. In this case, the additional structures are curtain-walling sections (or brackets for curtain walling sections).

FIG. 3c shows how a curtain-walling section 4 may be fixed in position relative to the floor slab sub structure 2 of the building. A bracket 11 is fixed to the U-shaped channel 8 by passing through the bracket 11 an elongate fastener 12 which is initially aligned parallel to the length of the U-shaped channel 8. The elongate fastener 12 may then be rotated such that it extends across the width of the U-shaped channel (i.e. perpendicular to its length), such that it cannot be removed from the U-shaped channel (i.e. the lips of the channel prevent removal of the elongate fastener). The bracket 11 may then be fixed in position by securing the elongate fastener by way of a nut 13.

The bracket 11 is of a sufficient length to overhang the side of the building and the floor slab sub structure 2. The curtain-walling section 4 may be attached to the bracket, and therefore suspended from the floor slab sub structure 2, by attaching the curtain-walling section 4 to the bracket 11. The curtain-walling section can be attached to the bracket 11 by way of a conventional nut and bolt arrangement 14.

FIG. 3c shows how the curtain-walling section 4 may be satisfactorily suspended from a floor slab sub structure 2 of a building in order to clad a building. However, the method and apparatus described with reference to FIGS. 3a to 3c has at least one serious deficiency. This deficiency is illustrated in FIGS. 4a to 4c.

FIG. 4a is generally the same as FIG. 3a. However, in FIG. 4a a worker has stepped onto the metal mesh 7 causing it to deform, i.e. the metal mesh is no longer horizontal and parallel to the floor slab sub structure 2. A worker's boot 15 is illustrated in FIG. 4a as an aid to understanding one of the possible causes of the deformation of the metal mesh 7. It can be seen from FIG. 4a that due to the deformation of the metal mesh 7, the U-shaped channel 8 is no longer level with the floor slab sub structure 2, but is slightly tilted (i.e. misaligned).

The misaligned U-shaped channel 8 is fixed in position when concrete 10 is poured in and around the U-shaped channel and allowed to set. The actual pouring of the concrete can cause further misalignment of the U-shaped channel 8.

FIG. 4c illustrates the theoretical situation that would arise if the curtain-walling section 4 were fixed in position relative to the floor slab sub structure 2 and misaligned U-shaped channel 8 as described in relation to FIG. 3c. It can be seen in FIG. 4c that due to the misalignment of the U-shaped channel 8, the curtain-walling section 4 is not parallel to the sides of the side shuttering 5, and that it is not parallel to the side of the building. If the curtain-walling sections 4 are not parallel to the sides of the building, there could be a number of undesirable consequences. For example, the curtain-walling sections may give the building an appearance, which is not aesthetically pleasing. More importantly perhaps, the misalignment of the curtain-walling sections 4 may reduce the insulation on the building or even its structural integrity. Furthermore, if the curtain-walling sections 4 were aligned as shown in FIG. 4c, a large amount of stress and strain may be induced in the bracket 11 and parts connecting the bracket 11 to the curtain-walling section 4 and U-shaped element 8. These stresses and strains may eventually cause the curtain-walling section 4 to come loose, or at least damage the concrete 10 surrounding the U-shaped element 8 which can also reduce the structural integrity of the building.

Although in theory the problems described in relation to FIG. 4c are possible, in practice most builders would not attempt to fix the curtain-walling section 4 to the U-shaped channel 8 when or if they noticed that the U-shaped channel 8 was not aligned correctly. A more likely scenario would be that the builders would have to chip away at the concrete 10 surrounding the U-shaped channel 8 in order to realign it and reset it in a correct position. Whereas this course of action would ensure that the structural integrity of the building was not compromised (as described earlier) realigning the U-shaped channel 8 may take a considerable amount of time (e.g. 45 mins to 1 hour). Any delay in the construction of the curtain-walling sections may have knock on delays for other contractors, for example electricians and decorators wishing to commence work on the interior of the building. Such delays can incur significant expense. It is desirable to avoid these delays and consequential expense.

FIGS. 5 to 7 illustrates a clamping apparatus 20 in accordance with an embodiment of the present invention. The clamping apparatus 20 is provided with two clamps. A first clamp is arranged to clamp around side shuttering 5 for the floor slab. The first clamp comprises a first clamp surface 21 and an opposable second clamp surface 22. The first clamp surface 21 is fixed in position, whereas the second clamp surface 22 is moveable relative to the first clamp surface 21 along a threaded shaft 23, which extends from the first clamp surface 21 and through the second clamp surface 22. A wing nut 24 is provided adjacent to the second clamp surface 22, and is rotatable about the threaded shaft 23 to secure the clamping apparatus 20 on an object (e.g. the side shuttering 5 of FIGS. 3 and 4 and as shown in FIG. 7). Any suitable clamping arrangement may be employed. For example, the second clamp surface could be fixed in position, and the first clamp surface moveable. Alternatively, both clamp surfaces could be moveable relative to one another, so long as the movement is releasably fixable (i.e. the positioning of the clamp surfaces can be fixed, but is not permanent and can be changed).

The clamping apparatus 20 is provided with a guide rail 25. The guide rail 25 extends from the second clamp surface 22 towards and through the first clamp surface 21. The guide rail 25 makes the clamping apparatus 20 more rigid.

The first clamp surface 22 is provided with an elongate arm 26. The elongate arm 26 extends away from and parallel to the threaded shaft 23. Provided on the elongate arm 26 is a second clamp. The second clamp is provided with an elongate fixing element 12. The elongate fixing element 12 is provided with a threaded shaft 27 that extends through the elongate arm 26. The threaded shaft 27 and elongate fixing element 12 are fixed in position by a wing nut 28. The wing nut 28 can be tightened to clamp the elongate fixing element 12 in position. An object can be clamped between the elongate fixing element 12 and the elongate arm 26. The elongate arm 26 also has distance markings to assist with connection location of the clamp 28.

When not fixed in position by the wing nut 28, the elongate fixing element 12 may be moved along a slot provided in the elongate arm 26. Once the elongate fixing element 12 has been moved to an appropriate location, its position can be fixed relative to the elongate arm 26 by tightening the wing nut 28. Repositioning of the elongate fixing element 12 can be achieved by untightening the wing nut 28 and sliding the elongate fixing element 12 along the slot provided in the elongate arm 26.

The clamping apparatus 20 may have a support leg that is screw threadedly retained in a threaded tube associated with the second clamping surface for height adjustment. The support leg is provided to give additional support and stability to the clamping device, which would otherwise be supported only by the side shuttering. The support leg has a handle at its top end for rotating the leg to move it up or down as necessary.

The clamping apparatus 20 can be constructed from any suitable material. For example, the clamping apparatus 20 can be constructed from aluminium, steel, etc.

Use of the clamping apparatus 20 of FIG. 5 is as follows. The clamping apparatus 20 is attached to the side shuttering 5. The clamping apparatus 20 is attached by positioning the first clamp surface 21 inside the shuttering and positioning the second clamp surface 22 outside the shuttering. The second clamp surface 22 is moved such that it is in contact with the shuttering 5 while, at the same time, the first clamp surface 21 is in contact with the inside of the shuttering. The clamping apparatus 20 is then fixed in position relative to the shuttering 5 by tightening the wing nut 24 about the threaded shaft 23. The support leg, if present is then rotated until it bears against the deck shuttering with the arm of the clamping apparatus held parallel to the deck shuttering.

The threaded shaft 23 is perpendicular to the outer edge of the building. Due to this alignment of the threaded shaft 23, the elongate arm 26 extends parallel to the deck shuttering for the floor slab.

A U-shaped channel 8 is clamped in position between the elongate fixing element 12 and the elongate arm 26 using a wing nut 28 and threaded shaft 27. The U-shaped channel 8 can be clamped in position before or after the clamping apparatus 20 has been attached to shuttering. The elongate fixing element 12 can be moved to a desired location along the length of the elongate arm 26.

Since the elongate arm 26 extends parallel to the deck shuttering, and since the U-shaped channel 8 is clamped to the elongate arm 26, the U-shaped channel 8 is also aligned parallel to the deck shuttering, as well as being level with the uppermost surface of the side shuttering.

Concrete is then poured into the shuttering and the U-shaped channel becomes fixed in the correct position when the concrete sets, after which the clamping apparatus is removed and curtain walling can be fixed to the U-shaped channel as shown in FIG. 7.

It will be appreciated that the method and apparatus used to apply curtain-walling to the building described in relation to FIGS. 5 to 8 is a vast improvement over the apparatus and method described in relation to FIGS. 3 and 4. In FIGS. 3 and 4, alignment of the U-shaped channel depends strongly on the attachment of the U-shaped channel 8 to the metal mesh 7. If this metal mesh 7 is not level when attachment to the U-shaped channel 8 is made, the U-shaped channel 8 will not be aligned correctly and will need realignment before the curtain-walling sections can be attached to their term. In stark contrast, the method and apparatus according to the present invention allows the U-shaped channel 8 to be quickly and accurately aligned. The fact that the U-shaped channel 8 is clamped to the elongate arm 26 of a clamping apparatus 20 means that the alignment of the U-shaped channel 8 is not affected when concrete is poured into the shuttering. Since alignment of the U-shaped channel 8 using the method and apparatus according to the present invention is quick and accurate, time and expense can be saved when compared with prior art techniques, where realignment of the U-shaped channel 8 is often required.

It will be appreciated that the guide rail 25 is not essential to the operation of the clamping apparatus 20. The guide rail only serves to add rigidity and structural support to the clamping apparatus 20. Similarly, it will be appreciated that the second clamp (e.g. that comprising the wing nut 28, threaded shaft 27 and elongate fixing element 12) need not be moveable along the length of the elongate arm 26. However, the movement of the second clamp along the elongate arm 26 allows a certain degree of flexibility in the positioning of the U-shaped channel 8, as will be described further below.

As described above it can be seen from the Figures that the substantially U-shaped channel 8 is not exactly U-shaped, but has inwardly facing lips. As stated above, the lips are used to prevent a fixing element from moving out of the channel when the fixing element has been appropriately positioned in the channel. It will be appreciated that the channel need not be U-shaped, but can be of another shape which defines a channel for reception of a fixing element. For example, the cross-section of the channel can be substantially triangular, trapezoidal, rectangular etc., the channel having lips to prevent a fixing element from moving out of the channel when the fixing element has been appropriately positioned in the channel. Such channels are referred to generally as fixing channels (see for example the fixing channels manufactured and sold by Ancon Building Products, Sheffield, UK).

An elongate fixing element is a fixing element which has a greater length than width. For example, an elongate fixing element may be an elongate piece of metal, such as an abbeysolt. By using an elongate fixing element, the fixing element can be fixed in position in a fixing channel. To do this, the elongate fixing element is oriented so that its length is parallel to that of the channel. The elongate fixing element is then located in the channel. The elongate fixing element is then rotated such that its length is perpendicular to the length of the channel, the lips of the fixing channel preventing the fixing element from being removed.

1-25. (canceled)

26. A clamping apparatus, comprising:
a first clamp provided with:
a first clamp surface;
a second clamp surface; and
a substantially straight shaft, the first clamp surface and second clamp surface being arranged to be moveable relative to each other along the shaft to clamp an object between the first clamp surface and the second clamp surface, at least one of the clamp surfaces being releasably fixable, and a second clamp provided on an arm which extends from the second clamp surface, the arm extending in a direction substantially parallel to the shaft.

27. A clamp as claimed in claim 26, wherein the first clamp surface is fixed in position relative to the shaft, and the second clamp surface is moveable relative to the first clamp surface.

28. A clamp as claimed in claim 27, wherein the shaft extends from the first clamp through the second clamp surface.

29. A clamp as claimed claim 26, wherein the second clamp is moveable along the arm, in a direction substantially parallel to the length of the shaft.

30. A clamp as claimed in claim 29, wherein the second clamp is moveable along a slot provided in the arm.

31. A clamp as claimed in claim 30, wherein the arm has distance markings thereon.

32. A clamp as claimed in claim 26, further comprising a guide rail, the guide rail being substantially straight and parallel to shaft, extending between the first clamp surface and second clamp surface.

33. A clamp as claimed in claim 32, wherein the guide rail extends from the second clamp surface through the first clamp surface.

34. A clamp as claimed in claim 26, wherein the shaft is provided with a securing element for releasably securing at least one of the clamp surfaces in position when the first clamp is arranged to clamp an object.

35. A clamp as claimed in claim 26 wherein the second clamp comprises a shaft which extends through the arm, the shaft being arranged to engage with a securing element on one side of the arm, and the shaft being provided with a clamp surface on another side of the arm which is arranged to clamp an object in between the clamp surface and the arm.

36. A clamp as claimed in claim 35, wherein the clamp surface is provided by an elongate fixing element.

37. A clamp as claimed in claim 36, wherein the elongate fixing element is shaped to engage with a fixing channel.

38. A clamp as claimed in claim 34, wherein the securing element is a wing nut.

39. A clamp as claimed in claim 26 including a leg for supporting the clamp above deck shuttering for the floor slab sub structure.

40. A clamp as claimed in claim 39, wherein the leg is height adjustable relative to one of the clamp surfaces.

41. A clamp as claimed in claim 40, wherein the leg is screw threadedly adjustable.

42. A method of clamping a fixing channel in position relative to a floor slab sub structure, comprising: moving at least one of a first clamp surface and a second clamp surface of a first clamp along a substantially straight shaft, and releasably fixing the at least one clamp surface to clamp between the first clamp surface and the second clamp surface side shuttering for forming a floor slab; using a second clamp which is attached to the first clamp to clamp the fixing channel so that the fixing channel is parallel to the deck shuttering for the floor slab and in a position substantially parallel to and away from the shaft.

43. A method as claimed in claim 42, wherein the fixing channel is clamped in position before the first clamp is used to attach the clamp to side shuttering for a floor slab.

44. A method as claimed in claim 42, wherein the fixing channel is clamped in position after the first clamp is used to attach the clamp to side shuttering for the floor slab. sub structure and upstand.

45. A method as claimed in claim 42 further comprising setting the fixing channel in position before removing the clamp and unclamping the fixing channel.

46. A method as claimed in claim 45, wherein the fixing channel is fixed in position using concrete or cement

47. A method as claimed in claim 46, wherein the concrete or cement is poured onto the floor slab deck shuttering, the extent to which the concrete or cement flows across the deck shuttering being restricted, at least in part, by the side shuttering.

48. A method as claimed in claim 45, wherein a bracket is attached to the fixing channel.

49. A method as claimed in claim 48, wherein a curtain walling section is attached to the bracket.

50. A method as claimed in claim 45, wherein a curtain walling section is attached to the fixing channel.
